(19) United States
(12) Patent Application Publication
(10) Pub. No.: US 2014/0345607 A1
(43) Pub. Date: Nov. 27, 2014

(54) Breathing mask

(71) Applicant: MOLDEX-METRIC, INC., CULVER CITY, CA (US)

(72) Inventor: ROMAN SKOV, Walddorfhaslach (DE)

(73) Assignee: MOLDEX-METRIC, INC., CULVER CITY, CA (US)

(21) Appl. No.: 13/999,842

(22) Filed: Mar. 27, 2014

(30) Foreign Application Priority Data
May 22, 2013 (DE) 13168818.6

(51) Int. Cl. A62B 27/00; A62B 7/10

(52) U.S. Cl. CPC A62B 27/00; A62B 7/10
USPC 128/202.22

(57) ABSTRACT

The invention relates to a breathing mask, in particular for human beings, comprising a flexible mask body designed to fit over a mouth and nose on a user's face, at least one sealing lip for a gas-proof fit on the user's face, comprising at least one inhalation valve penetrating the mask body, a filter material assigned to the inhalation valve and an exhalation valve penetrating the mask body. It is intended that a manually actuable test valve is arranged downstream of the exhalation valve and designed to provide a gas passage from the exhalation valve to the surroundings in its normal state and to close said passage in its actuated state.

The present invention relates to breathing masks, in particular for human beings. Breathing masks are commonly used to allow a human being to breathe freely in an environment that carries polluted or toxic air which could be dangerous for the breathing system, in particular in human beings. Common breathing masks usually comprise a flexible mask body designed to fit over a mouth and nose on a user's face such that both, nose and mouth of the user are within the mask body to keep them separated from the surroundings. The mask body usually comprises at least one sealing lip for a gas-proof fit on the user's face. Furthermore, the mask body comprises at least one inhalation valve penetrating the mask body, whereby the inhalation valve is designed to let gas or air to pass only from the surroundings into the mask. Usually, a filter material is assigned to the inhalation valve, such that the inhaled air will be filtered before entering the user's breathing/respiratory system. Furthermore, known breathing masks also comprise an exhalation valve penetrating the mask body. Like the inhalation valve, the exhalation valve allows air to pass only in one direction. In the case of the exhalation valve air is only allowed to pass from the inside of the mask assigned to the user to the surroundings.

For the function of the breathing mask it is essential that all elements are fitted tight into the mask body and that the mask body is tightly seated on the user's face, such that no air/gas can pass through the mask body bypassing the filter material of the inhalation valve. However, there are no breathing masks available which allow the user to conduct an easy test of the functionality of the breathing mask in terms of leak proofness or tightness.

It is therefore the object of the present invention to create a breathing mask which gives the user an easy-to-use feature that allows testing of air leakage.

### SUMMARY OF THE INVENTION

The object of the invention is reached by a breathing mask with the features as follows. With the inventive breathing mask a user can simply test his or her breathing mask by one simple manual actuation and a simultaneous exhalation procedure. The inventive breathing mask comprises a manually actuable test valve which is arranged downstream of the exhalation valve and which is designed to provide a gas passage from the exhalation valve to the surroundings in its normal state and to close said passage in its actuated state. The test valve is assigned to the exhalation valve. In its normal state the test valve allows the air coming from the exhalation valve to pass into the surroundings. Once the test valve is manually actuated, it closes said passage such that air or a gas can no longer flow from the exhalation valve to the surroundings. Therefore, by actuating the test valve the only allowed gas passage is closed which would normally lead to a situation where a user can no longer exhale and a pressure builds up within the mask body. However, if the breathing mask is defect, for example due to a wrongly inserted filter material (element) which allows gas or air to pass into the surroundings by bypassing the exhalation valve and/or the filter material, the user would still be able to exhale and no pressure would build up within the mask. In that situation, it can be assumed that the breathing mask is either not leakage proof or is not in the right position on the user's face or the mask does not fit the wearer. The inventive breathing mask therefore gives the user the possibility of an easy checkup regarding the correct seat of the breathing mask on the user's face and whether or not the breathing mask itself is as tight/leakage proof as it should be.

According to a preferred embodiment of the invention, the test valve comprises a valve body having at least one opening therein providing said gas passage from the exhalation valve to the surroundings, and further comprising a moveable valve element which is designed to close said passage if actuated. The test valve is therefore designed in a very simple manner having an opening which is closeable by the moveable valve element. To keep the valve element in its normal state in the open position an elastically deformable element can be provided which pushes the valve element in its open position and which can be elastically deformed, when the valve element is pushed into the closed position. The elastic element is preferably designed as spring element.

According to a preferred embodiment of the invention, the valve element is designed as elastically deformable valve element itself. This means, that no extra spring element or elastically deformable element is needed. The valve element itself comprises a rigidity which forces the valve element back into its open state, when it is not actuated or pushed into its closed state by the user. Preferably the valve element is designed as elastically deformable valve flap which is attached to the mask body on one end and moveable freely on the other end.

According to a particularly preferred embodiment of the invention, the valve element is designed in one piece with the mask body. Herewith, the valve element is designed integral with the mask body such that the inventive breathing mask does not require additional single parts for the production. Since the mask body itself is flexible, the elastically deformable design of the valve element is natural.

According to a preferred embodiment of the invention, the test valve is designed in one piece with the mask body. In this case, not only the valve element, but also the valve body is designed in one piece with the mask body. Herewith, a particularly safe and easy-to-use and to assemble breathing mask is provided. If the valve body and the valve element are both integral with the mask body, the tightness of the test valve in its closed state can be easily guaranteed.

According to a further embodiment of the present invention, the test valve comprises a cup-like protrusion extending outward from the mask body, whereby at least a circumferential side wall of the protrusion constitutes the valve body and comprises the at least one opening. By providing the cup-like protrusion it is possible to arrange the opening such that exhaled air does not leave the test valve in the direction of the eyes of the user, such that, for example, a fogging of protection goggles is prohibited. The opening is therefore particularly arranged such that it directs the exhaled air sidewards or downwards. Due to the design of the cup-like protrusion, the cup-like protrusion is hollow on the inside, thereby constituting a passage from the exhalation valve to the surroundings by use of the at least one opening in the circumferential side wall.

Preferably, the at least one opening borders on a bottom part of the cup-like protrusion, whereby the bottom part constitutes the elastically deformable valve element. The opening is thus arranged on one side of the circumferential side wall such that the opening is limited by the side wall and the bottom part or the valve element. By actuating the test valve, the valve element is pushed towards the side wall or the exhalation valve such that the size of the opening is reduced until it is fully closed. This is the simplest and most cost effective way to provide the test valve on the breathing mask. All that is needed is the cup-like protrusion and the at least one opening arranged as described before. The opening can be cut into the material after the mask body or the valve element has been manufactured or the opening is designed as clearance during manufacturing of the mask body.

According to a further embodiment of the invention, the at least one opening particularly comprises at least one curved section opposed to the bottom part or the valve element. The curved section opposed to the bottom part has the advantage that if the bottom part is actuated, that means pushed into the direction of the exhalation valve, the bottom part's deformation leads to a bend within the bottom part which cooperates with the curved section of the opening in a gastight manner. Preferably, the curved section is designed such that the curved section of the opening corresponds to the bottom part or the valve element in its bend state to guarantee air-tightness.

According to a preferred embodiment of the invention, the at least one opening is formed at least essentially as circle segment, whereby the circle segment particularly comprises the said curved section and a straight section which is assigned to the bottom part of the cup-like protrusion in its normal state.

Preferably, the circumferential side wall or the valve body comprises two of said openings arranged diametrically opposed to one another. With respect to the overall design of the mask body, the two openings are arranged, in particular horizontally, diametrically opposing one another. The opposed arrangement of the openings allows the bottom part to be easily pushed into the direction of the exhalation valve in order to close the opening.

Preferably, the cup-like protrusion comprises a circular or polygonal contur. That means that the circumferential side wall is either designed as circle or comprises a polygonal form. While a polygonal contur would allow for the test valve to be easier to actuate, the circular form would make the manufacturing less cost-intensive. In the end, the contur of the valve body or the cup-like protrusion can be chosen based on the overall design of the breathing mask.

According to a further embodiment of the invention, the test valve is arranged in a nose region of the mask body. Herewith, the test valve is arranged centrally on the mask body. Due to this, the test valve is arranged in an area, where a user would intuitively look or feel for the test valve. Furthermore, a central arrangement in the nose area would render the breathing mask suitable for right handers as well as left handers.

In the following, the invention shall be explained with reference to the drawings whereby:

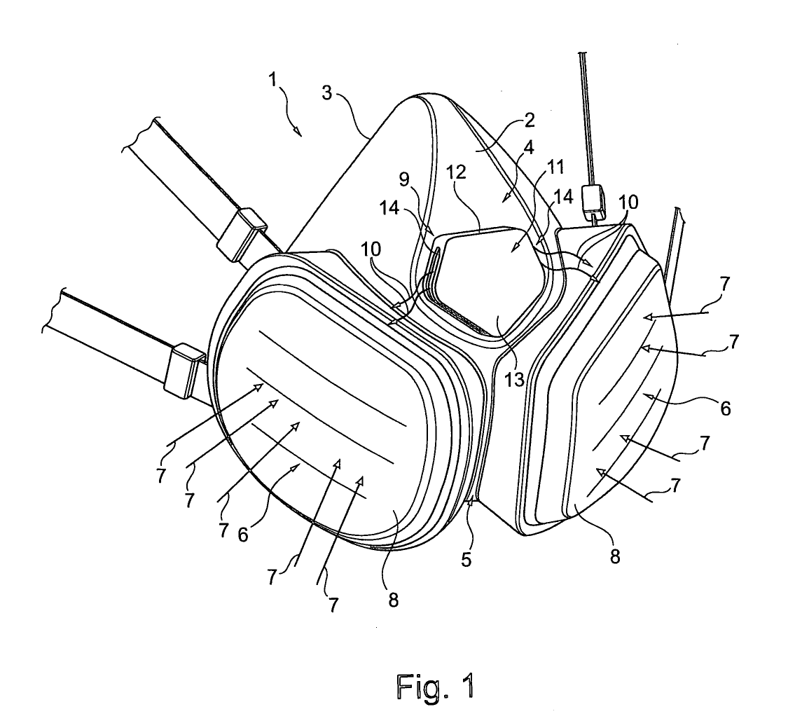

FIG. 1 shows an embodiment of a breathing mask in a perspective representation,

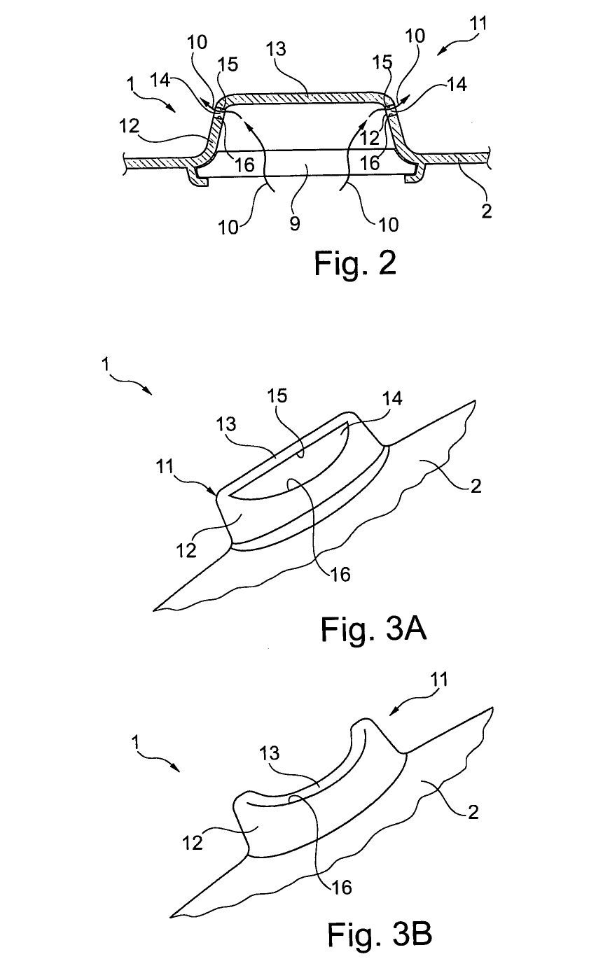

FIG. 2 shows a test valve in a cross-sectional representation, and

FIGS. 3A and 3B illustrate the function of the test valve of the breathing mask.

FIG. 1 shows in a perspective representation a breathing mask 1 for human beings. The breathing mask 1 comprises a mask body 2 which is made of a flexible rubber material. The mask body is designed such that it fits over the mouth and nose of a user and onto the user's face such that a tight or gas-proof connection with the user's face is provided. For this, the mask body 1 is provided with a sealing-lip 3 on its backside assigned to the user's face.

The mask body 2 further comprises a nose region 4 and a lower mouth region 5. The breathing mask 1 further comprises two inhalation valves 6 which are arranged essentially in the mouth region 5 left and right of a vertical centerline of the mask body 2. The inhalation valves allow air to pass through the mask body 2 from the surroundings to the user's face, as indicated by arrows 7. To each of the inhalation valves 6 a filter element 8 made of filter material is assigned such that the inhaled air has to pass through the filter material before it reaches the user.

The breathing mask 1 further comprises an exhalation valve 9 which also penetrates the mask body 2. The exhalation valve 9 allows air 25 only to pass from the user through the mask body 2 to the surroundings, as indicated by arrows 10.

Furthermore, a test valve 11 is assigned to the exhalation valve 9 and - in the present representation—conceals the exhalation valve 9. The test valve 11 is arranged downstream of the exhalation valve or on top of it, viewed from the front as shown in FIG. 1.

The test valve 11 is designed in one piece with the mask body 2. It comprises a valve body 12 and a valve element 13. The valve body 12 and the valve element 13 form together a cup-like protrusion extending outward from the mask body 2, whereby the valve body 12 constitutes a circumferential side wall of the protrusion and the valve element 13 forms the bottom part, as shown in FIG. 2.

The circumferential side wall or the valve body 12 comprises two openings 14 which are arranged diametrically opposed to one another on the sides of the test valve 11. The openings 14 constitute a passage from the exhalation valve 9 to the surroundings. For this, the cup-like protrusion is designed hollow.

FIG. 3A shows the test valve 11 in a side view. The openings 14 arranged in the valve body 12 border to the valve element 13. The openings 14 are shaped as circle segment with a straight section 15 formed by the valve element 13 or the bottom part of the cup-like protrusion, and a curved section 16 which opposes the valve element 13.

FIG. 3B shows the test valve 11 of FIG. 3A in its actuated state. If the user manually actuates the test valve 11 by pushing the bottom part/the valve element 13 inwards or towards the exhalation valve 9, the valve element 13 is elastically deformed such that it bends in- ward as shown in FIG. 38. If the valve element 13 is pushed inward fully, the openings 14 are fully closed. In this state, the valve element 13 rests upon the curved section 16 of the opening 14. Since the openings 14 are arranged diametrically opposed to one another on the circumferential side wall of the valve body 9, the valve element 13 can easily be pushed into the actuated position as shown in FIG. 3B. Now that the openings 14 are fully closed, the only exhalation passage through the mask body 2 is shut.

If the mask body 2 is positioned on the face of the user such that the sealing lip 3 provides an airproof connection, the user should not be able to exhale if he actuates the test valve 11 as described above. However, should the user be able to exhale, this means that either the mask body 2 is positioned wrong on the face or that the breathing mask 1 has a leakage somewhere. By pressing the test valve 11 during exhaling the user can therefore easily test the breathing mask 1 with regard to its correct position/seat on the face and its functionality.

Although the invention has been described with reference to particular embodiments, it is to be appreciated that various adaptations and modifications may be made and the invention should only be limited by the appended claims.

1. Breathing mask, in particular for human beings, comprising a flexible mask body designed to fit over a mouth and nose on a user's face, at least one sealing lip for a gas-proof fit on the user's face, comprising at least one inhalation valve penetrating the mask body, a filter material assigned to the inhalation valve and an exhalation valve penetrating the mask body, characterized in that a manually actuable test valve is arranged downstream of the exhalation valve and designed to provide a gas passage from the exhalation valve to the surroundings in its normal state and to close said passage in its actuated state.

2. Breathing mask of claim 1, characterized in that the test valve comprises a valve body having at least one opening therein providing said gas passage from the exhalation valve to the surroundings, and further comprises a moveable valve element which is designed to close said passage if actuated.

3. Breathing mask of claim 2, characterized in that the valve element is designed as elastically deformable valve element.

4. Breathing mask of claim 2, characterized in that the valve element is designed in one piece with the mask body.

5. Breathing mask of claim 1, characterized in that the test valve is designed in one piece with the mask body.

6. Breathing mask of claim 1, characterized in that the test valve comprises a cup-like protrusion extending outward from the mask body, whereby at least a circumferential side wall of the protrusion constitutes the valve body and comprises the at least one opening.

7. Breathing mask of claim 6, characterized in that the at least one opening borders on a bottom part of the cup-like protrusion, whereby the bottom part constitutes an elastically deformable valve element.

8. Breathing mask of claim 6, characterized in that the at least one opening comprises at least one curved section opposed to the bottom part or the valve element.

9. Breathing mask of claim 6, characterized in that the at least one opening is formed at least essentially as circle segment.

10. Breathing mask of claim 6, characterized in that the cup-like protrusion comprises a circular or polygonal contour.

11. Breathing mask of claim 1, characterized in that the valve body comprises two of the openings arranged diametrically opposed to one another.

12. Breathing mask of claim 1, characterized in that the test valve is arranged in a nose region of the mask body.
